(19) United States
(12) Patent Application Publication
(10) Pub. No.: US 2007/0033165 A1
(43) Pub. Date: Feb. 8, 2007

(54) Efficient evaluation of complex search queries

(75) Inventors: Dafna Sheinwald, Nofit (IL); Benjamin Sznajder, Jeruslem (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/195,128

(22) Filed: Aug. 2, 2005

(51) Int. Cl. G06F 17/30

(52) U.S. Cl. 707/3

(57) ABSTRACT

A computer-implemented method, for searching a corpus of documents having an index, includes receiving a complex query, which includes a plurality of words conjoined by operators including a root operator and at least one intermediate operator. Respective advancement potentials are assigned to the words in the complex query. A query processor applies a consultation method to the words and operators in the complex query in order to choose one of the words responsively to the advancement potentials. The query processor advances through the index in order to find a document containing the chosen one of the words, and evaluates the document to determine whether the document satisfies the complex query.

### FIELD OF THE INVENTION

The present invention relates generally to methods and systems for searching a corpus of documents, and specifically to efficient methods for evaluating complex queries over such a corpus.

### BACKGROUND OF THE INVENTION

The amount of data available for search continues to grow rapidly. At the same time, users have come to expect their search engines to provide rapid response and accurate results regardless of the complexity of the queries that they pose. Therefore, the runtime performance of search engines in evaluating complex queries has become an increasingly important concern.

A variety of query processing strategies are known in the art. For large corpora of data, an object-oriented document-at-a-time (DAAT) approach is widely used. This sort of approach is described, for example, by Burrows in U.S. Pat. No. 5,809,502. The index (often referred to in the art as an “inverted index”) to a database is organized as a plurality of index entries, wherein each index entry comprises a word and an ordered list of locations where the word occurs in the database. The index entries are ordered first according to a collating order of the words, and second according to the order of the locations of each associated word (i.e., records, such as document pages, on which the word occurs).

A query is parsed into terms and operators. Each term is associated with a corresponding index entry, while the operators relate the terms. A basic stream reader object is generated for each term of the query. The basic stream reader object sequentially reads the locations of the corresponding index entry to determine a target location. A compound stream reader object is generated for each operator. The compound stream reader object references the basic stream reader objects associated with the terms related by the operator. The compound stream reader object returns locations of words within a single record according to the operator.

Various methods have been suggested for improving the efficiency of object-oriented DAAT query evaluation. For example, Broder et al. describe a method based on a new Boolean construct called WAND (Weak AND) in “Efficient Query Evaluation using a Two-Level Retrieval Process,” Proceedings of CIKM'03 (ACM Press, 2003), pages 426-434. The two-level approach described in this paper begins with an approximate evaluation, using only partial information on term occurrences, followed by full evaluation of promising candidates. The WAND operator has a next( ) method, which traverses the index to find the next candidate document to evaluate. The next( ) method invokes a number of helper methods, including pickTerm( ), which receives as input a set of terms (i.e., the operands of WAND) and selects the term whose iterator (stream reader) is to be advanced. The authors state that an optimal selection strategy for pickTerm( ) will select the term that will produce the largest expected skip. In the implementation described in this paper, pickTerm selects the term with the maximal inverse document frequency (idf, equal to the inverse of the number of documents in the corpus that contain the term).

### SUMMARY OF THE INVENTION

Disclosed embodiments of the present invention provide methods, apparatus and computer software products for searching a corpus of documents having an index. A query processor receives a complex query, which includes a plurality of words conjoined by operators including a root operator and at least one intermediate operator. Respective advancement potentials are assigned to the words in the complex query. The query processor applies a consultation method to the words and operators in the complex query in order to choose one of the words responsively to the advancement potentials. The query processor then advances through the index in order to find a document containing the chosen one of the words, and evaluates the document to determine whether the document satisfies the complex query.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a system for query evaluation, in accordance with an embodiment of the present invention;

FIG. 2 is a graph that schematically illustrates a query tree, in accordance with an embodiment of the present invention;

FIG. 3 is a flow chart that schematically illustrates a method for query evaluation, in accordance with an embodiment of the present invention;

FIG. 4 is a flow chart that schematically illustrates a method for consultation of leaf objects in a query tree, in accordance with an embodiment of the present invention; and

FIG. 5 is a flow chart that schematically illustrates a method for consultation among the operands of an AND operator, in accordance with an embodiment of the present invention.

### DETAILED DESCRIPTION OF EMBODIMENTS

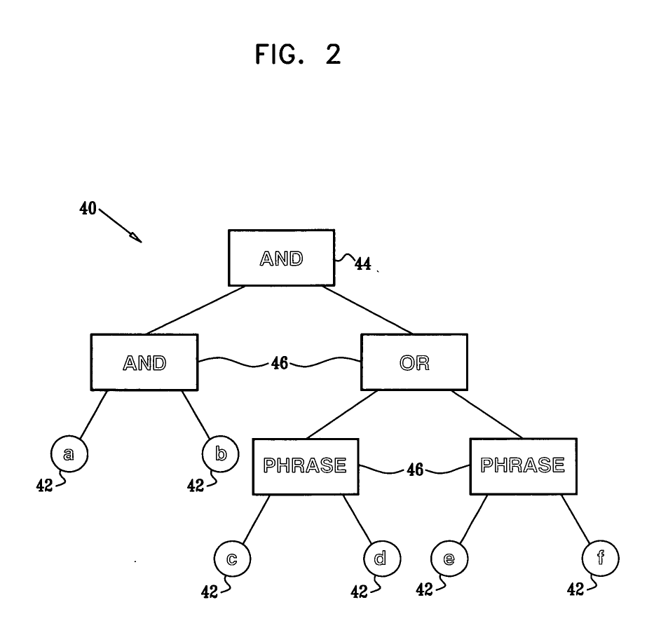

Embodiments of the present invention, as described hereinbelow, provide methods for improving the efficiency of evaluation of complex queries using document-at-a-time (DAAT) techniques. A “complex query,” as the term is used in the context of the present patent application and in the claims, comprises multiple query words, which are conjoined by multiple levels of query operators. In other words, one or more of the operators in a complex query have another operator as at least one of their operands. (An exemplary complex query is shown below in FIG. 2.) The evaluation efficiency is enhanced by defining a method of “consultation,” whereby a query processor chooses the one word, among all the words in the query, that has the greatest advancement potential at any given point in the evaluation process. The query processor then checks the index entries of this word to find the next document that is to be evaluated. The advancement potential is typically defined such that high advancement potential is indicative of a relatively low likelihood of finding the word in any given document.

As a result of using this technique, the query processor can often skip over large numbers of documents. Therefore, the number of times that the query processor must access the index in evaluating a given query is generally reduced, by comparison with object-oriented methods known in the art. Although methods known in the art may discriminate among the operands of a single query operator in deciding which term to advance, they do not consult all the words in all the levels of a complex query, and as a result, they do not always choose the one word with the greatest advancement potential. Since the index is typically stored on disk, a disk read operation is incurred each time the query processor must access the index. Thus, by reducing the number of times that the index must be accessed, embodiments of the present invention reduce the number of disk reads and thus accelerate the process of query evaluation.

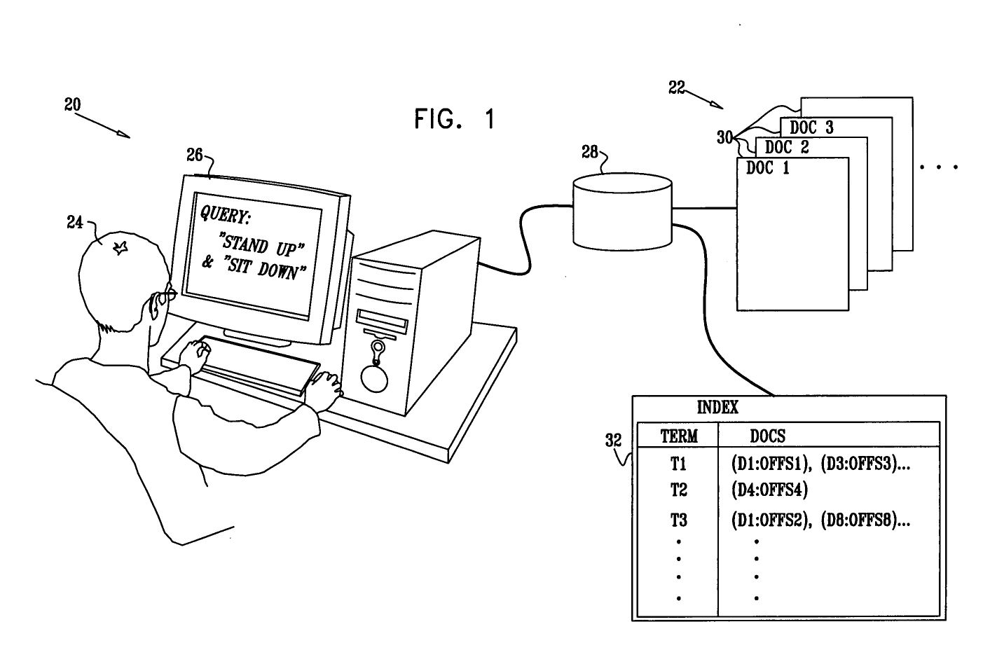

FIG. 1 is a schematic, pictorial illustration of a system 20 for querying a corpus 22 of information, in accordance with an embodiment of the present invention. Typically, a user 24 inputs a query to a query processor 26. The query in this example is “stand up” & “sit down,” i.e., find all documents in corpus 22 that contain both the phrase “stand up” and the phrase “sit down.” The query in this case contains four words, which are conjoined in two pairs by the PHRASE operator (which requires that the operands be found together in the target document in consecutive order). The two phrase pairs are conjoined by the root operator AND. This is a simple example of a complex query, and the principles of the present invention apply equally to queries with larger numbers of terms and larger hierarchies of operators, including operators of different types (such as OR, negation and span operators). The methods described hereinbelow may similarly be applied usefully to nested queries framed in formats such as the extensible markup language (XML).

Corpus 22 comprises multiple documents 30, which are stored in storage media, such as a disk 28. Typically, the documents in large corpora (such as the World Wide Web or an enterprise data system) are stored in many different storage devices, which are distributed among different locations. Documents 30 may comprise substantially any sort of data files or records known in the art, ranging from books and articles, to Web pages, to database records, for example. Each document has a unique document identifier number (docid).

In evaluating queries, processor uses an inverted index 32, which is typically stored on disk 28. The index comprises a postings list for each term appearing in corpus 22. Typically, each term is a word, i.e., a certain string of characters (not necessarily a natural language word). Each item in the postings list for a term t specifies a location of a single occurrence of t in the corpus. The location is typically specified in the form docid:offset, wherein offset indicates the word count from the beginning of the document at which the term is found. The postings in index 32 are generally sorted in order of docid and in order of offset among multiple occurrences of a term in one document. Index 32 supports a postings iterator, or cursor, providing a method next(1), which advances to the first element in the postings list for a selected term with location≧1.

Processor 26 selects the word to advance (using next( )) at each stage in query evaluation by choosing the word with the greatest advancement potential that has not yet advanced within the current document or range. Thus, for example, in evaluating the above-mentioned query “stand up” & “sit down,” processor 26 might initially determine that “sit” has the greatest inverse document frequency (idf), and hence the greatest advancement potential of the four words in the query. The processor will therefore invoke next( ) to find the first occurrence of “sit” in the postings list, in some document D_{N}. At this point, the word with the next-highest advancement potential could be “stand.” Therefore, processor 26 invokes next(first location within document D_{N}) to find the first occurrence of “stand” beginning from the start of document D_{N}. (There is no point in checking postings for preceding documents, since these documents are known to contain no occurrences of “sit.”) The processor checks the postings of the common words “up” and “down” only if both “sit” and “stand” are found in the same document. Therefore, the dense postings of these common words are advanced only occasionally. In evaluating the query, processor 26 is thus able to skip over many documents, and the number of times processor 26 must access index 32 on disk 28 is accordingly reduced.

Typically, processor 26 comprises a general-purpose computer, which is programmed in software to carry out the functions described in this patent application. This software may be downloaded to processor 26 in electronic form, over a network, for example, or it may alternatively be stored on tangible media, such as magnetic, optical, or non-volatile electronic memory media. Further alternatively, some of the functions of processor 26 may be performed by dedicated hardware circuits.

FIG. 2 is a graph that schematically illustrates an exemplary query tree 40, in accordance with an embodiment of the present invention. Tree 40 represents the complex query (a AND b) AND ((PHRASE “cd”) OR (PHRASE “ef”)). The terms a, b, c, d, e, f represent arbitrary words, i.e., entries in index 32, and they appear as leaves 42 in the query tree. The words are conjoined in sub-queries (for example, “a AND b”) by the intermediate operators AND, OR and PHRASE, and these sub-queries are conjoined by the root operator AND. Thus, tree 40 has a root node 44, corresponding to AND, and intermediate nodes 46 corresponding to the intermediate operators. Any complex query may be represented in this manner as a hierarchical tree, with a root node and at least one intermediate node linking leaves corresponding to the query words, in the general form of FIG. 2.

In order to evaluate a complex query, processor 26 associates a type of program object, referred to hereinbelow as a “harmonic object,” with each of the nodes in tree 40. The harmonic objects include leaf objects, which are associated with each of leaves 42, and node objects, which are associated with root and intermediate nodes 46. The leaf objects (also referred to as “basic objects”) implement the next(1) method for searching through their respective postings in index 32, as described above. Each leaf object has a current location field c1, which indicates the location of the index entry found for the corresponding word the last time the leaf object invoked next(1), i.e., the highest index entry for this word found so far in the current search. Each leaf object also has an advancement potential ap, which is generally indicative of the rarity of the corresponding word in corpus 22, i.e., of the likelihood that a search for that word will skip over documents before reaching the next occurrence of the word. For example, ap for a given word may be equal to the idf of that word. Alternatively or additionally, other measures of ap may be used.

Each harmonic object implements a method known as consult(from,to), by which it investigates possible occurrences of the corresponding node in a range between from and to in corpus 22. Detailed implementations of the method for different types of nodes are described in the Appendix hereinbelow. Generally speaking, for leaves 42, consult(from,to) simply evaluates the possibility of occurrence of the corresponding word in the range, based on the current value of c1 relative to the consultation range. For nodes 44 and 46, consult(from,to) asks the children of the node (i.e., the operands of the operator to which the node corresponds, which may be leaves or intermediate nodes) about the possibility of occurrence of each of the children in the range in question. When the children do not give a definite “no” or “yes” answer (as explained hereinbelow), consult(from,to) chooses the best operand to advance.

The consultation process takes place recursively, invoking from the root 44 down to the leaves 42, and returning from leaves 42 up to root node 44, prior to each invocation of next(1). Upon conclusion of this process, consult(from,to) of the root node chooses the leaf that is to advance (i.e., to invoke next(1)) in the next iteration of the search. Although this consultation process consumes CPU resources of processor 26, it can be conducted entirely in the main memory of the processor and does not require access to disk 28. By optimizing the choice of the leaf to advance, on the other hand, the consultation reduces the number of times processor 26 must access disk 28, and therefore reduces the overall runtime of the search.

In one embodiment of the present invention, obj.consult(from,to) returns a quadruple: (status, nearestPossible, basicObj, fromWhere), abbreviated hereinbelow as (sT, nP, bO, fW). The status field can take one of three possible values—Bingo, Possibly, and NoWay—specifying the current status of a possible occurrence of obj within the range [from,to], as determined by the current locations of the leaf objects:
Status=Bingo indicates that there is a known occurrence of obj within the specified range. (The precise location of the occurrence is given by the value or values of c1 of the corresponding leaf or leaves.) In such a case, the other fields in the quadruple are irrelevant, and may be set to 0 or NULL.
Status=NoWay if at least one leaf object is in a position (as given by c1) that makes an occurrence of obj in the specified range impossible. In this case, the basicObj and fromWhere fields are irrelevant and are set to 0 or NULL. The nearestPossible field is set to indicate the earliest possible location of the next occurrence of obj. This value will always be greater than to. For example, if c1 for node “a” in FIG. 2 is greater than the to value of the range specified by AND.consult(from,to) of AND node 46, then both node “a” and the AND node will return NoWay. nearestpossible will be set to the maximum value of c1 among the operands of AND.
Status=Possibly if neither Bingo nor NoWay applies, i.e., the occurrence of obj in the specified range can neither be confirmed or ruled out. In this case, the basicObj field identifies the leaf having the highest ap among all the leaves that are yet to advance in order to verify the next possible occurrence of obj, and fromWhere indicates the location from which this leaf is to advance. The value of nearestPossible is set to 0 or NULL. The determination of which leaves are candidates for basicObj in a given consultation by an operator node depends on the type of operator.

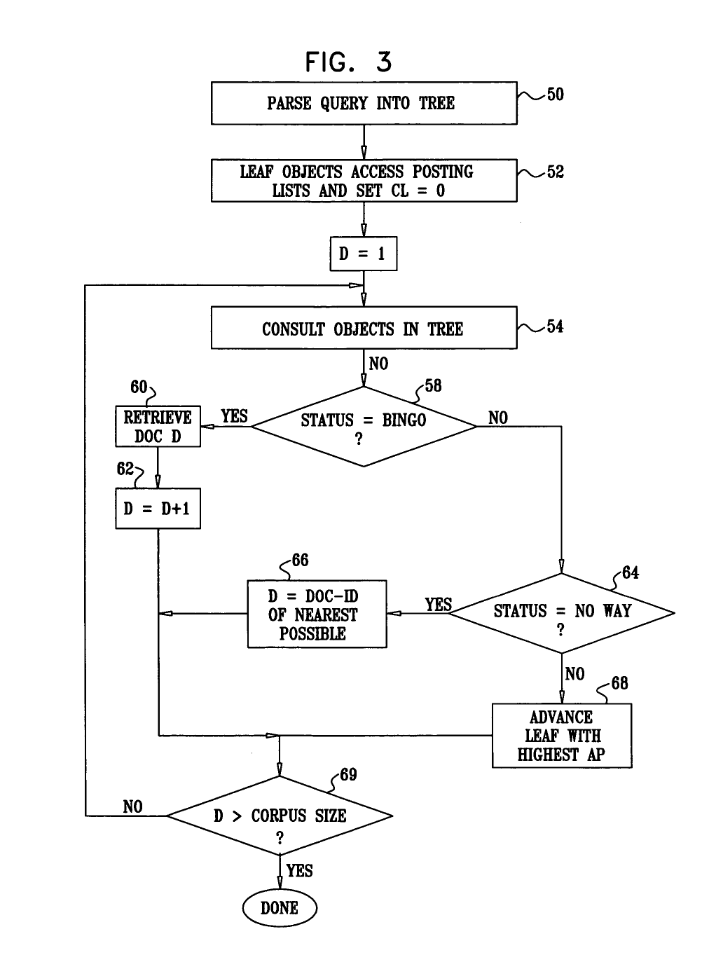

FIG. 3 is a flow chart that schematically illustrates a method for query evaluation, in accordance with an embodiment of the present invention. Upon receiving a query from user 24, processor 26 parses the query into a tree, like tree 40 (FIG. 2), at a parsing step 50. All of the leaf objects in the tree prepare to access their respective lists of postings in index 32, and initialize their current location values c1 to 0, at an initialization step 52. The value of the document ID, labeled D in the figure, is likewise initialized to the first document in corpus 22.

To begin the search, processor 26 invokes the root.consult( ) method, at a consultation step 54. Typically, the range of consult is set to extend over a single document, so that from is initially set to 1:0, i.e., the first location in document 1, and to is set to 1:∞, the last location in document 1. In subsequent iterations, consult( ) sets from=D:0 and to=D:∞, wherein D is the document ID of the currently-examined document. Alternatively, other range choices may be used. As explained above, root.consult invokes the consult( ) methods of the children of root node 44, which in turn invoke the consult( ) methods of their children, and so on down to leaves 42. The consultation step returns a value of the quadruple (sT, nP, bO, fW). In the initial iteration, root.consult will typically return sT=Possibly, with bO indicating the leaf with the highest ap, or sT=NoWay, with nearestpossible indicating the next document to check. On subsequent iterations through step 54, the result will be different.

The action taken by processor 26 following the consultation depends on the status returned by the consultation. If sT is found to be Bingo, at a success evaluation step 58, it means that the current document D satisfies the search query. Processor 26 accordingly retrieves the document (or adds the document to a list for subsequent retrieval), at a document retrieval step 60. The document ID for the next stage in the search is incremented to D+1, at a document increment step 62.

Otherwise, processor 26 determines whether the status returned by step 54 is NoWay, at a failure evaluation step 64. In this case, nP indicates the next possible document that may satisfy the query. The value of nP is determined by the root.consult method based on the subsidiary nP values returned by the children of the root node. For root AND node 44, for example, nP will indicate the higher value of nP returned by either of the operands of the AND operation. The document ID for the next stage in the search is advanced to this value of D, at a document advance step 66.

Alternatively, processor 26 may determine at step 64 that sT=Possibly. In this case, the bO field indicates which of leaves 42 is to advance next, and fW gives the point from which the leaf is to begin its advance. For this purpose, processor 26 invokes the method bO.next(fW), at a leaf advance step 68. As noted earlier, this method will advance the selected leaf (i.e., the word corresponding to the leaf) through the postings for this word in index 32, beginning with location fW, to find the next occurrence of the word. Another round of consultation is then carried out hierarchically, without changing the range consulted for most recently (i.e., D does not change). Eventually, when all the possible word occurrences that can satisfy the query have been exhausted, D is advanced to a default value that is greater than the highest document ID in corpus 22.

After taking the action indicated by root.consult, the processor checks the current value of D, at a location checking step 69. (This step is not required if the value of D did not advance in the last round of consultation.) If the value is greater than the highest document ID in corpus 22, the processor concludes that it has completed the search over the entire corpus, and the search terminates. Otherwise, the processor returns to step 54 and invokes root.consult again in order to determine the next action to be taken.

The inventors have found that the use of consultation, as described hereinabove, reduces substantially the number of times a query processor must access the index on disk in evaluating most complex queries by comparison with object-oriented query processing methods that are known in the art. In the case of the “stand up” & “sit down” query described above, for example, the consultation method focuses the search on the less common terms, “stand” and “sit.” By contrast, conventional object-oriented methods typically advance these less common terms in alternation with the accompanying common terms “up” and “down.” Consequently, in a trial search of the above query over the TREC-8 collection (containing over half a million documents), the inventors found that the consultation-based method described above required about 12,000 disk access operations to find all occurrences of “stand up” & “sit down”, in contrast to more than 24,000 disk access operations when a conventional object-oriented search method was used. Similar results were obtained for other complex queries.

Although the embodiments described herein use certain specific implementations of the principles and methods of consultation, alternative implementations will be apparent to those skilled in the art and are considered to be within the scope of the present invention. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

### APPENDIX—CONSULATION METHODS FOR EXEMPLARY OBJECTS

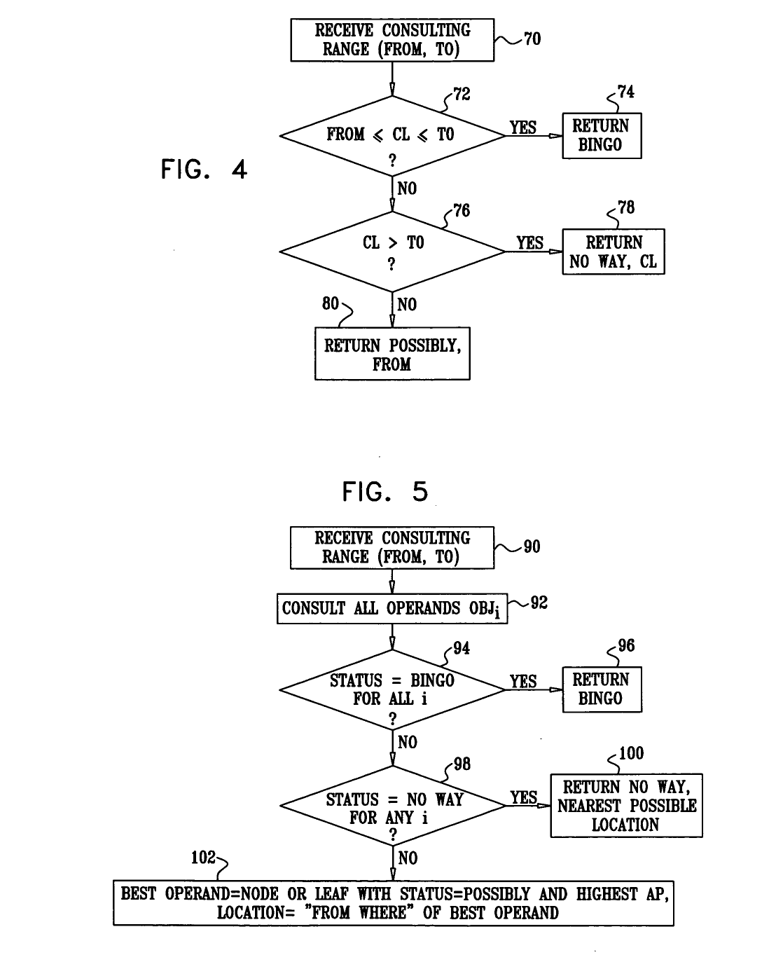

FIG. 4 is a flow chart that schematically illustrates an implementation of the consult( ) method for leaf objects (query words), in accordance with an embodiment of the present invention. The method is also listed in pseudocode form in Table I below.

Processor 26 determines the range (from,to) of the current invocation of consult( ), at a range determination step 70. It then checks the current location c1 of the index entry found for the word in question against this range, at an inner range checking step 72. If c1 is within the range, it means that the previous invocation of next( ) for this word found an occurrence of the word in a document within the present consultation range. Consequently, consult( ) returns the answer Bingo, at a confirmation step 74.

Otherwise, the processor checks whether c1 for this word is beyond the upper bound of the current range (i.e., c1>to), at an out-of-range determination step 76. If so, it means that next( ) has already searched the current range for this word and found no occurrences. In this case, consult( ) returns NoWay, at a denial step 78. The quadruple returned by consult( ) includes the current value of c1 for this word, for use by the parent node of the leaf in determining the location from which the next consultation should begin.

If the results of both steps 72 and 76 are negative, the processor determines that the current range (from,to) has not yet been searched for this word. Therefore, consult( ) returns the result Possibly, at a possible indication step 80. The quadruple returned in this case identifies this word as the basic object and from as the fromWhere value for the purpose of subsequent invocation of next( ) should the root choose to advance this word (in which case the root will invoke next(fromWhere) to find the next occurrence of the word).

TABLE I
WORD CONSULT( )

| | |
|---|---|
| 1. | Function word::consult(from,to) |

| | |
|---|---|
| 2. | if from ≦ this.cl ≦ to return (Bingo,0,0,0) |
| 3. | if this.cl > to return (NoWay,this.cl,0,0) |
| 4. | /* this.cl < from */ |
| 5. | return (Possibly,0,this,from) |

FIG. 5 is a flow chart that schematically illustrates an implementation of the consult( ) method for AND nodes, in accordance with an embodiment of the present invention. The method is also listed in pseudocode form in Table II below. This method is used whether the AND operation in question is at the root node or at an intermediate node in the query tree.

Processor 26 determines the range (from,to) of the current invocation of consult( ), at a range determination step 90. It then consults all the operands objᵢ of this AND node, at a consultation step 92. In other words, this node invokes the consult( ) methods of all of its children with the same from and to that it received. It checks the results to determine whether all the operands have returned Bingo, at a success checking step 94. If so, it means that the current locations of all operands are within the received values of from and to. Assuming from and to are set to values at the boundaries of one page, this result indicates that the current locations of all operands are in the same document. Therefore, the consult( ) method returns Bingo, at a confirmation step 96.

Otherwise, the query processor checks whether any of the operands has returned NoWay, at a failure checking step 98. If so, there is no document in the current range that can satisfy the query or sub-query of the present AND node. Therefore, consult( ) returns the response NoWay, at a denial step 100. The nearest possible location returned by the method in this case is the highest nearestpossible value among the operands that returned NoWay at step 92.

In all other cases, consult( ) returns the response Possibly, at a possible indication step 102. The best operand reported by consult( ) is the operand with the highest advancement potential ap among all the operands that reported a status of Possibly at step 92, and fromWhere is set to the fromWhere value reported by this best operand. Each node receives the highest ap value among its operands. Intermediate nodes report this value to their parent node in the query tree. The root node (which has no parent) invokes next(fromWhere) with respect to the best operand.

TABLE II
CONSULT( ) FOR “AND” NODE

| | |
|---|---|
| 1. | Function AND::consult(from,to) |

| | |
|---|---|
| 2. | for objᵢ operand of this |

| | |
|---|---|
| 3. | (sTᵢ,nPᵢ,bOᵢ,fWᵢ) [symbol] objᵢ.consult(from,to) |

| | |
|---|---|
| 4. | if for all i, sTᵢ=Bingo, return (Bingo,0,0,0) |
| 5. | if for some i, sTᵢ=NoWay |

| | |
|---|---|
| 6. | return (NoWay,maxᵢ{nPᵢ},0,0) |

| | |
|---|---|
| 7. | bestOperand [symbol] arg max_{i:sTi=Possibly}{bOᵢ.ap} |
| 8. | return (Possibly,0,bO_{bestOperand},fW_{bestOperand}) |

Table III below schematically illustrates an implementation of the consult( ) method for PHRASE nodes, in accordance with an embodiment of the present invention. This implementation is similar to AND.consult( ), with the addition of an alignment constraint. The operands of PHRASE are all words, and the operator imposes an order obj₁, obj₂, . . . , objₖ. In other words, for an occurrence of PHRASE in a location loc in some document, each object obiᵢ occurs in a respective location loc+i−1.

TABLE III
CONSULT( ) FOR PHRASE NODE

| | |
|---|---|
| 1. | Function PHRASE::consult(from,to) |

| | |
|---|---|
| 2. | for objᵢ operand of this |

| | |
|---|---|
| 3. | (sTᵢ,nPᵢ,bOᵢ,fWᵢ) [symbol] objᵢ.consult(from,to) |

| | |
|---|---|
| 4. | if for all i, sTᵢ=Bingo and operand locations |

align

| | |
|---|---|
| 5. | return (Bingo,0,0,0) |

| 6. | /* find the implied earliest possible starting |
|---|---|
| | location for phrase occurrence */ |
| 7. | earliest [symbol] maxᵢ{objᵢ.cl−i+1} |
| 8. | /* do not start phrase before from */ |
| 9. | if earliest < from, earliest [symbol] from |
| 10. | /* if earliest is too close to or beyond upper |
| | bound to, no occurrence is possible */ |
| 11. | if earliest+k−1 > to |

| | |
|---|---|
| 12. | return (NoWay,earliest,0,0) |

| | |
|---|---|
| 13. | /* occurrence is still possible */ |
| 14. | bestOperand [symbol] arg max_{i:obji.cl}_{-i+1<earliest}{objᵢ.ap} |
| 15. | return (Possibly,0,obj_{bestoperand}, |

earliest+bestOperand−1)

Consult( ) methods for conjunctive operators with range limitations (for example, an operator requiring that its operands occur within a specified number of words of one another) may be constructed based on the principles embodied in the implementations for AND and PHRASE that are given above.

Table IV below schematically illustrates an implementation of the consult( ) method for OR nodes, in accordance with an embodiment of the present invention. The OR operator benefits less from the use of consultation than do the conjunction-based operators, since by definition of the operator, the search cannot skip past a given document until it has verified that none of the operands occur in that document. For coherence with the methods listed above, the implementation in Table IV selects the operand with highest ap to advance at each iteration. Alternatively, in the case of OR, a different operand could be chosen, such as the operand with lowest ap.

TABLE IV
CONSULT( ) FOR “OR” NODE

| | |
|---|---|
| 1. | Function OR::consult(from,to) |

| | |
|---|---|
| 2. | for objᵢ operand of this |

| | |
|---|---|
| 3. | (sTᵢ,nPᵢ,bOᵢ,fWᵢ) [symbol] objᵢ.consult (from,to) |

| | |
|---|---|
| 4. | if for some i, sTᵢ=Bingo, return (Bingo,0,0,0) |
| 5. | if for all i, sTᵢ=NoWay |

| | |
|---|---|
| 6. | return (NoWay,minᵢ{nPᵢ},0,0) |

| | |
|---|---|
| 7. | bestOperand [symbol] arg max_{i:sTi=Possibly}{bOᵢ.ap} |
| 8. | return (Possibly,0,bO_{bestOperand},fW_{bestOperand}) |

1. A computer-implemented method for searching a corpus of documents having an index, the method comprising:
receiving a complex query, which comprises a plurality of words conjoined by operators comprising a root operator and at least one intermediate operator;
assigning respective advancement potentials to the words in the complex query;
applying a consultation method to the words and operators in the complex query in order to choose one of the words responsively to the advancement potentials;
advancing through the index in order to find a document containing the chosen one of the words; and
evaluating the document to determine whether the document satisfies the complex query.

2. The method according to claim 1, wherein receiving the complex query comprises parsing the query to define a tree having a root node corresponding to the root operator, at least one intermediate node corresponding to the at least one intermediate operator, and leaves corresponding to the plurality of words.

3. The method according to claim 2, wherein applying the consultation method comprises associating a respective consultation method with each of the nodes and leaves, and invoking the consultation method recursively over the nodes and leaves in the tree in order to choose one of the leaves.

4. The method according to claim 3, wherein each of the nodes has children in the tree, and wherein invoking the consultation method comprises determining a respective node status for each of the nodes responsively to a child status of the children of each of the nodes.

5. The method according to claim 1, wherein applying the consultation method comprises specifying a range in the index and determining, with respect to each of the operators, whether the query can be satisfied by a document in the range.

6. The method according to claim 5, wherein applying the consultation method comprises, upon determining that the query cannot be satisfied by any of the documents in the range, selecting a next possible document following the range from which to continue the search.

7. The method according to claim 5, wherein applying the consultation method comprises, upon determining that one or more documents within the range may satisfy the query, selecting the words to search in the range according to an order of the advancement potentials of the words.

8. Apparatus for searching a corpus of documents, comprising:
a memory, which is arranged to store an index to the corpus; and
a query process, which is arranged to receive a complex query, which comprises a plurality of words conjoined by operators comprising a root operator and at least one intermediate operator, and to associate respective advancement potentials with the words in the complex query, and which is arranged to apply a consultation method to the words and operators in the complex query in order to choose one of the words responsively to the advancement potentials, to advance through the index in order to find a document containing the chosen one of the words, and to evaluate the document to determine whether the document satisfies the complex query.

9. The apparatus according to claim 8, wherein the query processor is arranged to parse the query to define a tree having a root node corresponding to the root operator, at least one intermediate node corresponding to the at least one intermediate operator, and leaves corresponding to the plurality of words.

10. The apparatus according to claim 9, wherein a respective consultation method is associated with each of the nodes and leaves, and wherein the query processor is arranged to invoke the consultation method recursively over the nodes and leaves in the tree in order to choose one of the leaves.

11. The apparatus according to claim 10, wherein each of the nodes has children in the tree, and wherein the query processor is arranged to determine a respective node status for each of the nodes responsively to a child status of the children of each of the nodes.

12. The apparatus according to claim 8, wherein the query processor is arranged to specify a range in the index and to determine, with respect to each of the operators, whether the query can be satisfied by a document in the range.

13. The apparatus according to claim 12, wherein the query processor is arranged, upon determining that the query cannot be satisfied by any of the documents in the range, to select a next possible document following the range from which to continue the search.

14. The apparatus according to claim 12, wherein the query processor is arranged, upon determining that one or more documents within the range may satisfy the query, to select the words to search in the range according to an order of the advancement potentials of the words.

15. A computer software product for searching a corpus of documents having an index, the product comprising a computer-readable medium in which program instructions are stored, which instructions, when read by a computer, cause the computer to accept a complex query, which comprises a plurality of words conjoined by operators comprising a root operator and at least one intermediate operator, and to associate respective advancement potentials with the words in the complex query, and cause the computer to apply a consultation method to the words and operators in the complex query in order to choose one of the words responsively to the advancement potentials, to advance through the index in order to find a document containing the chosen one of the words, and to evaluate the document to determine whether the document satisfies the complex query.

16. The product according to claim 15, wherein the instructions cause the computer to parse the query to define a tree having a root node corresponding to the root operator, at least one intermediate node corresponding to the at least one intermediate operator, and leaves corresponding to the plurality of words.

17. The product according to claim 16, wherein a respective consultation method is associated with each of the nodes and leaves, and wherein the instructions cause the computer to invoke the consultation method recursively over the nodes and leaves in the tree in order to choose one of the leaves.

18. The product according to claim 15, wherein the instructions cause the computer to specify a range in the index and to determine, with respect to each of the operators, whether the query can be satisfied by a document in the range.

19. The product according to claim 18, wherein the instructions cause the computer, upon determining that the query cannot be satisfied by any of the documents in the range, to select a next possible document following the range from which to continue the search.

20. The product according to claim 18, wherein the instructions cause the computer, upon determining that one or more documents within the range may satisfy the query, to select the words to search in the range according to an order of the advancement potentials of the words.
